(19) United States
(12) Patent Application Publication
(10) Pub. No.: US 2008/0228569 A1
(43) Pub. Date: Sep. 18, 2008

(54) Process for visually displaying information on products and services in waiting rooms

(76) Inventor: Rostislav S. Yankiver, New Rochelle, NY (US)

Correspondence Address: THEODORE JAY, SUITE 600, 16 N CHATSWORTH AVE, LARCHMONT, NY, 10538, US

(21) Appl. No.: 11/724,426

(22) Filed: Mar. 15, 2007

(51) Int. Cl. G06Q 30/00

(52) U.S. Cl. 705/14

(57) ABSTRACT

A process for visually displaying items of information of interest to individuals in attendance in offices offering personal services who are delayed in receiving such services.

### FIELD OF THE INVENTION

The present invention is directed toward a process for visually displaying items of information of interest to individuals in attendance in offices offering personal services who are delayed in receiving such services.

### BACKGROUND OF THE INVENTION

Individuals who are waiting to receive services in medical or dental waiting rooms or the like are virtually a captive audience. The present invention is intended to entertain, educate and otherwise attract their interest and at the same time promote the sales of products and services to such individuals

### SUMMARY OF THE INVENTION

In accordance with the principles of this invention a process is employed for visually displaying items of information of interest to individuals in attendance in offices offering personal services who are delayed in receiving such services.

This process utilizes a supplier who installs digital picture frame units or the like in such offices. The supplier retains ownership of the units and pays the owners of such offices to maintain said installations.

The supplier selecting these items for display and activates these units to display these items.

Each frame unit contains a plurality of memory storage chip slots in which an individual chip containing a selected information item when inserted in one of such slots causes the unit when in operation to display this item.

The supplier installs selected memory storage chips into the units. These chips contain information items selected to promote products or services of interest to said individuals;

The supplier removes these chips from the units and installs different chips to vary the information items displayed.

The chips are owned by the suppler and the information is owned by third parties who pay the supplier when supplier selects the information for display.

Additional objects and advantages of this invention will either be explained or will become apparent hereinafter.

### BRIEF DESCRIPTION OF THE DRAWINGS

FIG. 1 is a front view of a known type of digital picture frame unit as utilized in the inventive process.

FIG. 2 is a side view of the unit shown in FIG. 1, illustrating the slots for receiving known types of memory chips.

FIG. 3 is a plan view of these chips.

FIG. 4 illustrates use of the invention.

### DETAILED DESCRIPTION OF PREFERRED EMBODIMENT

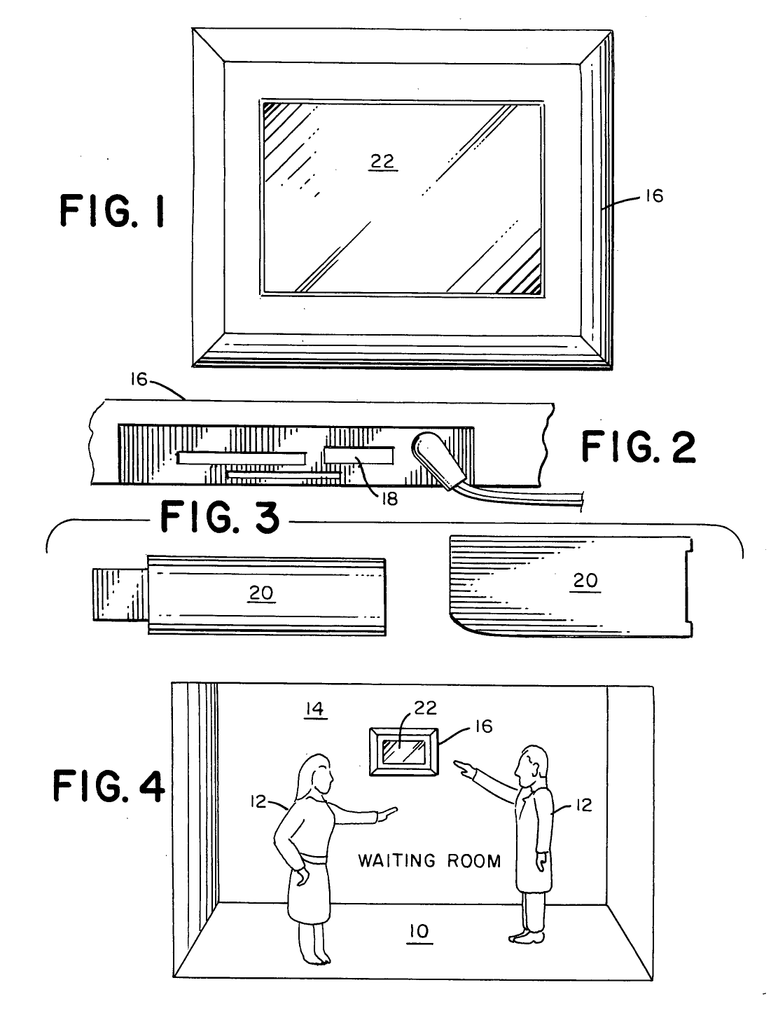

Referring now to FIGS. 1-4, a process is employed for visually displaying items of information of interest to individuals in attendance in offices offering personal services who are delayed in receiving such services.

An office 10 offers persons 12 personal services such as rehabilitation. To this end The office has a wall14 wherein a supplier installs digital picture frame units 16 on the walls in said offices. The units have supply screens 22. The supplier retains ownership of the units and pays the owners or managers of these offices so that these units will remain in position.

The supplier selects items for display and activates these units to display the selected items. The units are powered by connection to mains supply or batteries. Each frame unit 16 has a plurality of memory chip slots 18 in which an individual chip 20 containing a selected information item when inserted in one of said slots causes the unit when in operation to display this item.

The chips are owned by the suppler and the information is owned by third parties who pay the supplier when supplier selects the information for display.

Individuals 12 who are waiting to receive services in medical or dental waiting rooms or the like are virtually a captive audience. The display of these items is intended to entertain, educate and otherwise attract the interest of the individuals and at the same time promote the sales of products and services to such individuals.

While the invention has been described with specific reference to the drawing and detailed description, the protection solicited is to be limited only by the terms of the claims which follow.

What is claimed is:

1. A process for visually displaying items of information of interest to individuals in attendance in offices offering personal services who are delayed in receiving such services, said process comprising:
a supplier who arranges for the installation of digital picture frame units or the like in said offices, said supplier retaining ownership of the units and paying the owners of said offices to maintain said installations;
the supplier selects said items for display;
the supplier activates said units to display said items;
each frame unit having a plurality of memory chip slots in which an individual chip containing a selected information item when inserted in one of said slots causes the unit when in operation to display said item;
the supplier removes chips from the units and installs different chips to vary the information items displayed.

2. The process of claim 1 wherein the information on chips are owned by third parties who pay the supplier when supplier selects their information for display.
